(19) United States
(12) Patent Application Publication
(10) Pub. No.: US 2017/0118644 A1
(43) Pub. Date: Apr. 27, 2017

(54) METHOD FOR RECOVERY OF AN AUTHENTICATION CODE REQUIRED BY A CONTROL TERMINAL AND CORRESPONDING SYSTEM

(71) Applicant: SIGFOX, LABEGE (FR)

(72) Inventor: LUDOVIC LE MOAN, PIN JUSTARET (FR)

(21) Appl. No.: 15/318,881

(22) PCT Filed: Jun. 22, 2015
(86) PCT No.: PCT/EP2015/064006

§ 371 Date: Dec. 14, 2016

(30) Foreign Application Priority Data
Jun. 23, 2014 (FR) 1455817

(51) Int. Cl. H04W 12/06; H04L 29/06

(52) U.S. Cl. CPC H04W 12/06; H04L 63/0876; H04L 63/083; H04L 63/107; H04L 63/18

(57) ABSTRACT

Method for remote recovery by a terminal of at least one authentication code required by a control terminal. Control terminals located in a predefined geographic area is identified by a terminal. A request is sent by the terminal to a remote server according to a first communication protocol. The request is a demand for at least one authentication code corresponding to at least one of the control terminals selected from the identified control terminals. The authentication code is sent by the remote server to the terminal according to the first communication protocol. The authentication code corresponding to the selected control terminal is sent by the terminal via a second communication protocol.

### TECHNICAL FIELD

The present invention relates to the field of communication systems and more precisely relates to a method and system for retrieving an authentication code required by a control terminal such as a point of access to a shared network.

### PRIOR ART

Generally, the connection of a device or any other peripheral to a computer network, such as for example the Internet or a shared local network, via an access point or gateway, involves, beforehand, a procedure of authentication or identification of the device by this access point. Such an access point, which generally takes the form of a set-top box or of a card integrated into a router or a modem for example, therefore serves as an interface for allowing or preventing access of the device to the computer network.

Such an access point may especially be affiliated with a wired or wireless community network meeting the specifications of standards such as for example IEEE 802.11 (better known by the name WI-FI® for “Wireless Fidelity”), or IEEE 802.15 (better known by the name BLUETOOTH®), or IEEE 802.16 (better known by the name WIMAX® for “Worldwide Interoperability for Microwave Access”), or RFID (acronym for “Radio Frequency Identification”), or PLC (acronym for “Power-Line Communication”).

For example, in the case of a Wi-Fi access point (also called a Wi-Fi hotspot or Wi-Fi terminal), the procedure of authentication of the device especially involves the transmission of an authentication code by the device to the Wi-Fi access point. This authentication code may take the form of a security key (for example a WEP key, WEP standing for “Wired Equivalent Privacy”, or a WPA key, WPA standing for “Wi-Fi Protected Access”) or even take the form of an identifier followed by a password.

In practice, to connect to the shared network via a Wi-Fi access point, the device, such as a cell phone equipped with a module capable of communicating with the Wi-Fi access point, initiates, beforehand, a phase of discovering all the Wi-Fi access points located near the device. Indeed, in the context of Wi-Fi radiocommunication technology, each access point periodically emits a frame containing a beacon allowing it to be identified among the other access points of the network. Once this discovery phase has been carried out, the device or the user chooses the access point to which it or he wants to connect from the list of discovered access points. An exchange of data then begins between the device and the chosen access point, in which the access point requests from the device the corresponding authentication code, for example a WPA security key, which code the user will have acquired beforehand from the owner of the access point.

For example, some service providers provide free access to all their Wi-Fi access points provided that registration has been performed beforehand, generally via the Internet. The authentication code, which generally takes the form of an identifier and a password, is then valid for all the access points belonging to the same provider. However, some users sometimes forget to perform such a registration. Thus, the user therefore finds, when he is on a trip, that he does not have the authentication code required to connect to one of the access points of the provider, and therefore finds it impossible to access the Internet via his device.

Furthermore, the user of the cell phone may find himself in a geographical zone devoid of a Wi-Fi access point for which he has an authentication code. The user may also have forgotten to record or memorize these authentication codes or may be in possession of authentication codes that are no longer valid, in the case of codes that are only valid for a limited time for example. The user then finds it impossible to connect to the Internet via these Wi-Fi access points.

### SUMMARY OF THE INVENTION

The present invention therefore proposes to remedy these situations, by providing an alternative solution for retrieving such an authentication code. The aim of the invention is especially to increase the number of ways in which it is possible to retrieve an authentication code corresponding to a point of access to the Internet.

To this end, the present invention relates to a method for remotely retrieving by a device at least one authentication code required by a control terminal such as a point of access to a shared network.

According to the invention, this method comprises:
identification by the device of all or some of the control terminals located in a predefined geographical zone;
transmission of a request by the device to a remote server using a first communication protocol, this request being a request for at least one authentication code corresponding to at least one of the control terminals selected from the identified control terminals; and
on reception of the request by the server, interrogation by the server of a table stored in a database, this table comprising a list of control terminals associated with respective authentication codes; and
if the selected control terminal and the corresponding authentication code are stored in the table:
   i) extraction by the server of the authentication code associated with the selected control terminal;
   ii) transmission by the server of the extracted authentication code to the device using the first communication protocol; and
   iii) transmission by the device of said authentication code corresponding to said selected control terminal, via a second communication protocol.

The retrieving method therefore corresponds to an exchange mechanism aiming at authenticating in the context of an access to a shared network. The particularity of this retrieving method is that the communication protocol used between the device and the control terminal is different from the communication protocol used between the device and the remote server. The first and second communication protocols for example meet very different communication standards. In other words, the device uses two different communication channels, one to exchange data with the control terminal and the other to exchange data with the remote server.

It will therefore be understood that this retrieving method may be initiated at any time by the device, and especially during the process of authentication with the control terminal. The device may at any time retrieve an authentication code required by an already known or newly discovered control terminal.

Of course, the authentication code according to the present invention is not only limited to a security key or to an identifier, and it may especially comprise any information that the device must provide to the control terminal to allow said device to be authenticated by said control terminal.

The term “device” is understood to mean any piece of equipment coupled to hardware and/or software means allowing it to communicate with the control terminal and the remote server using respective communication protocols. Such a device may be fixed or movable and may for example take the form of a mobile station, a desktop computer, a cell phone, a smartphone, a tablet, a card, etc.

The hardware and/or software means may be directly integrated into the device or may be external modules connected to the device, for example via a connection meeting the USB (“Universal Serial Bus”) standard. For example, these hardware and/or software means may take the form of a hardware key (commonly referred to as a “dongle”) formed from integrated circuits coupled to a radio antenna compatible with a wireless radiocommunication technology. These hardware and/or software means may also be a network card compatible with an existing communication technology.

The device, the remote server and the control terminal may be located in different geographical zones, for example in different buildings, on different floors, or even be separated by a few meters or more.

The control terminal may be a point of access to a computer network such as the Internet, an enterprise network, or any other local network, but may also be a terminal for verifying and authorizing access to a building.

According to one particular embodiment, the control terminal is a point of access to a shared network, the authentication code being required by the access point to authorize access of the device to said shared network.

Preferably, the network into which the remote server is integrated is different from the network to which the access point is affiliated, for example in terms of infrastructure and/or in terms of communication technology implemented. In one particular case, the network to which the access point belongs may employ a high data rate communication technology with a medium range, of about one hundred meters for example, whereas the network to which the remote server belongs may employ a communication technology permitting communications only with a low data rate but over a long range, such as an Ultra Narrow Band, with a range of several tens of kilometers for example. Likewise, the server may be affiliated with a private local network and the control terminal may be affiliated with a shared community network.

Advantageously, the second communication protocol is compatible with an existing radiocommunication standard, which may be wireless or wired, such as for example the Ethernet standard, or a standard from the group IEEE 802.11 (Wi-Fi), IEEE 802.15 (Bluetooth, ZigBee), IEEE 802.16 (WiMAX), RFID, PLC, NFC (near-field communication technology), etc.

In one preferred embodiment, the first communication protocol is compatible with an ultra narrow band radio technology.

Such an ultra narrow band radio technology is more commonly referred to by the acronym UNB (for “Ultra Narrow Band”). In particular, UNB technology uses license-exempt frequency bands (i.e. bands that do not require a prior authorization from the authorities) to transmit data intended for or originating from connected pieces of equipment over a very narrow spectrum. By “very narrow spectrum”, what is meant is that the width of said spectrum is narrower than two kilohertz, or even narrower than one kilohertz. UNB technology allows low data rate (typically about 10 b/s to 1 kb/s) wireless radiocommunications over long distances (especially up to 40 km over free space), and is in particular very suitable for building low data rate communication networks such as machine-to-machine (M2M) or “Internet of things” networks. An exemplary communication system implementing such a UNB technology is described inter alia in the international patent application published under the number WO 2013/068559.

In practice, the step of identification by the device of the control terminals comprises a phase of discovering all or some of the control terminals located in the geographical zone surrounding the device, and a step of retrieving the identifier of at least one of the discovered control terminals.

Of course, the extent of the geographical zone depends on the means implemented to initiate this discovery phase. For example, the range of communication modules meeting one of the standards of the IEEE 802.11 group may be about one hundred meters.

All of the surrounding control terminals may be obtained by a geolocating method, by mapping, or even by listening for beacons transmitted by each of the control terminals according to a wireless radiocommunications standard.

Thus, the step of identification by the device of the control terminals includes steps of:
geolocating the device via a geolocating module incorporated into the device; and
searching, in a list of control terminals stored in a database coupled to the device, for at least one control terminal located in a geographical zone surrounding the device.

According to one variant, the method described above may furthermore comprise a step of checking additional conditions associated with the control terminal selected, by the remote server, to transmit to the device the corresponding authentication code.

In practice, each control terminal is characterized by an identifier that is specific thereto. Thus, the table stored in the database coupled to the remote server preferably comprises a list of these identifiers and the associated authentication codes. Of course, this list need not be unchangeable, and it is possible to make provision for it to be updated to reflect control terminals newly discovered by the device.

For example, the identifier of a control terminal may be its MAC address (MAC standing for “Media Access Control”). This MAC address, which is attributed by the IEEE, is a unique physical identifier of the control terminal, which is generally a network card or a similar network interface. This MAC address is sometimes called an Ethernet address, a UAA (for “Universally Administered Address”), a BIA (for “Burned-In Address”), etc. This MAC address has the advantage of being unique.

As one variant, the identifier of a control terminal may also be an SSID (for “Service Set Identifier”). This SSID corresponds to the name of the IEEE 802.11 standard wireless network with which the control terminal is affiliated.

As another variant, the identifier of the piece of equipment may also be defined by its geographical position, which may be obtained via geolocating means incorporated into the device for example.

The identifier may also be an IP address (IP standing for “Internet Protocol”). This IP address is an identification number attributed to each piece of equipment connected to a network. This IP address has the advantage of being unique when it is public.

In the case where the IP address is internal to a network, and is therefore not unique, just like an SSID, this identifier may be supplemented by an additional identifier, and for instance the aforementioned geographical position.

In practice, each control terminal may be identified in the table using one of the pieces of information listed above, namely its MAC address, its SSID, its IP address, its geographical position, or via a combination of all or some of these pieces of information.

In practice, when the MAC address of the control terminal to which the device wants to connect is unknown, the server may implement a method for discriminating between various control terminals located in a predefined geographical zone. This discriminating method may for example use the IP address and a piece of information relating to the geographical position of the control terminal selected by the device.

Another subject of the invention is a system for retrieving remotely at least one authentication code, comprising:
a remote server coupled to a table stored in a database and comprising a list of control terminals associated with respective authentication codes;
at least one control terminal; and
a device that is coupled to a first communication module able to exchange data with the remote server using a first communication protocol, and that is coupled to a second communication module able to exchange data with a control terminal using a second communication protocol.
   Furthermore, the device is able to:
identify all or some of the access terminals in a predefined geographical zone;
transmit a request to the remote server via the first communication module in order to request a least one authentication code required by at least one control terminal selected from the identified control terminals; and
transmit the required authentication code to the selected control terminal via the second communication module.
   Moreover, the server is able to:
on reception of the request from the device, interrogate the table and extract the authentication code associated with the selected control terminal; and
transmit the extracted authentication code to the device using the first communication protocol.

Advantageously, at least one of the first and second modules is integrated into the device.

Preferably, the first module implements all or some of the steps of the retrieving method defined above.

### BRIEF DESCRIPTION OF THE DRAWINGS

Other features and advantages of the invention will become more clearly apparent from its description given hereinafter for illustration purposes and in a non-limiting manner, and with reference to the appended drawings, in which:

FIG. 1 is a partial schematic representation of the communication system implementing the retrieving method according to one embodiment of the invention; and

FIG. 2 shows, by way of illustration, a flowchart of a few steps of the method according to one embodiment of the invention.

### DETAILED DESCRIPTION OF PARTICULAR EMBODIMENTS

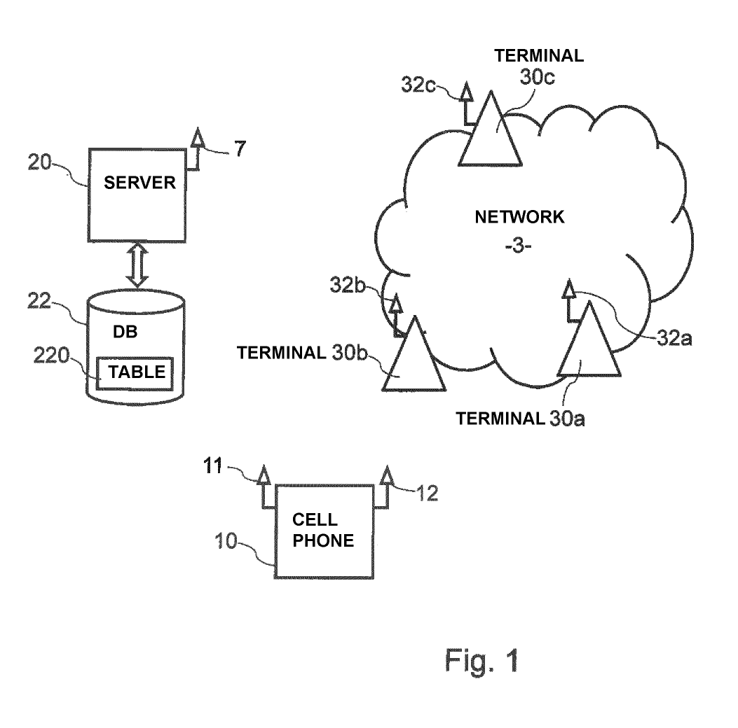

FIG. 1 schematically shows an exemplary communication system suitable for implementing one particular embodiment of the invention.

This system especially comprises control terminals 30a, 30b, 30c affiliated with a shared network 3. These control terminals 30a, 30b, 30c are separate from one another and form gateways to the shared network 3. In particular, each of the control terminals 30a, 30b, 30c serves as an interface allowing access to the shared network 3 to be authorized or prevented. Generally, each of the control terminals comprises hardware and/or software communication means 32a, 32b, 32c for communicating with a device using a predefined communication protocol. Furthermore, generally, access to the shared network 3 requires an authentication code, for example a security key, an identifier and a password, etc.

The system furthermore comprises a remote server 20 coupled to a database 22 in which a table 220 is stored. This table 220 especially contains a list of predefined control terminals, and the authentication codes associated with each of these listed control terminals. For example, the control terminals may be indexed in the table 220 by an identifier that is specific thereto. The control terminals may also be indexed in the table 220 by a combination of useful information allowing one control terminal to be distinguished from another control terminal. Generally, the remote server 20 also integrates hardware and/or software communication means 21 for communicating with a device using another communication protocol.

Moreover, the system furthermore comprises a device 10, for example a cell phone, coupled to communication modules 11, 12 suitable for ensuring the exchange of data between, on the one hand, the remote server 20 and, on the other hand, the control terminals 30a, 30b, 30c, using the respective communication protocols.

Below, the invention will be described in the particular case where the control terminals 30a, 30b, 30c are affiliated with a wireless community network meeting the specifications of the Wi-Fi standard, and where the remote server 20 is compatible with a UNB (“Ultra Narrow Band”) radio technology.

The device therefore comprises a first radiocommunication module 11 compatible with the UNB technology, for communicating with the remote server using the protocol defined by this UNB technology, and a second radiocommunication module 12 compatible with the Wi-Fi standard, for communicating with the Wi-Fi terminals using the Wi-Fi communication protocol.

In the particular context of such a network, each Wi-Fi control terminal 30a, 30b, 30c (which will be referred to as Wi-Fi terminals hereinafter) periodically emits a signal (or beacon) to signal its presence, and to broadcast information such as its radio characteristics and its specific identifier that differentiates it from the other access points of the network. Such an identifier is commonly called a MAC address.

The device 10, to connect to the Wi-Fi network, initiates, via its second communication module 12, a phase of discovering the Wi-Fi terminals 30a, 30b, 30c that are within its range by listening for these beacons.

Of course, this discovery phase is not obligatory insofar as the device may for example be coupled to a database containing a list of Wi-Fi terminals indexed by their location. In this particular case, the device may quite simply use a geolocating tool to determine its geographical position and interrogate this database to establish all of the Wi-Fi terminals located nearby.

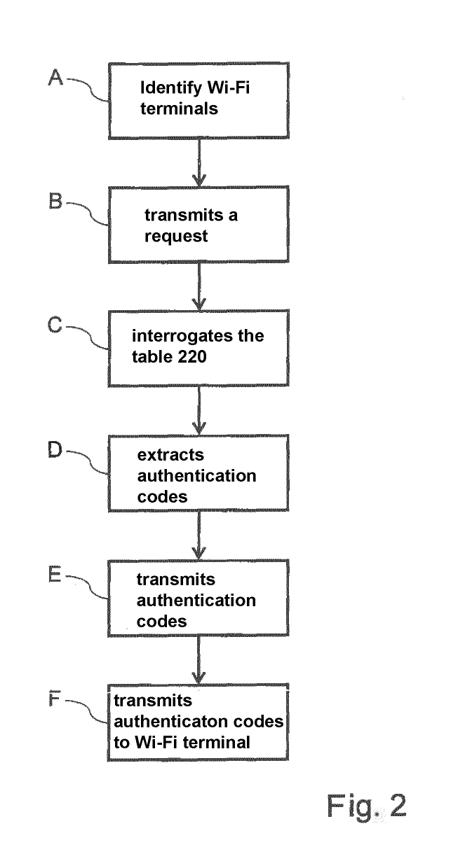

Once the Wi-Fi terminals have been identified (step A in FIG. 2), the device or the user selects the Wi-Fi terminal to which it or he wishes to connect from the identified Wi-Fi terminals 30a, 30b, 30c. The device 10 then executes the steps illustrated in FIG. 2 to retrieve from the remote server 20 the authentication codes associated with one or more identified Wi-Fi terminals 30a, 30b, 30c. In particular, the device 10 transmits (step B) a request to the remote server 20 via the first communication module 11. On reception of this request, the remote server 20 interrogates (step C) the table 220 to determine whether the one or more Wi-Fi terminals selected by the device 10 are stored in the table 220 and, if so, extracts (step D) and transmits (step E) to the device 10 the corresponding authentication codes. Once these codes have been received, the device 10 may transmit (step F) the corresponding authentication code to one of the selected Wi-Fi terminals via the second communication protocol.

Of course, the transmission of the authentication codes by the server to the device may be subject to particular conditions such as, for example, an expression of consent to receive marketing material, a payment, etc.

In another particular embodiment, the control terminals may serve to authorize or prevent access to a building, or even open a door to a block on provision of an access code. In this particular case the device, for example a badge or even a smartphone, obviously integrates various means for communicating with the remote server and the control terminals using the respective communication protocols. For example, the device may integrate an RFID antenna for communicating with the control terminals and an antenna using UNB technology for communicating with the remote server. Conventionally, the RFID control terminal may periodically emit a signal containing its unique identification number, for example as defined in the EPC (“Electronic Product Code”) standard. As in the preceding case, the device retrieves this identification number and interrogates the remote server to retrieve the corresponding access code. On reception of the request, the remote server consults its database and, after having checked the recorded authorizations, may decide to send or not the corresponding access code to the device.

It is therefore understood that the solution of the invention may be implemented independently of the size of the network. This solution may especially be applicable in an industrial situation but also in a domestic situation. Thus, it is possible to implement the method of the invention to ensure the exchange of information between a domestic appliance and a maintenance service. For example, the domestic appliance, such as a washing machine, a cooking appliance, etc., may be equipped with the various communication modules described above allowing it to retrieve, from the remote server of the invention, an authentication code in order to automatically connect to an available Wi-Fi terminal. This connection may especially be useful for exchanging information such as the existence of a malfunction or fault, or that is necessary to update the appliance, etc., with a remote maintenance service or a device of the owner of the appliance.

Of course, it will be understood that all or some of the steps presented above may be executed automatically by the device.

It is therefore clear apparent from the preceding that the alternative solution proposed above makes it possible for a user of a device to connect to the Internet via the use of two different communication channels, one to retrieve remotely and at any time the necessary authentication codes, and the other to connect to the desired network. For example, the first communication channel may use a UNB technology optimized for low data rate communications over long distances and the second communication channel may meet a wireless high data rate radiocommunication standard such as the Wi-Fi standard. Thus, the device may retrieve at any time the authentication code to connect itself to a Wi-Fi terminal. Furthermore, such an authentication code may be retrieved remotely, namely far from the remote server, since UNB technology permits communications over distances of several tens or even hundreds of kilometers.

1-11. (canceled)

12. A method for retrieving remotely by a device at least one authentication code required by a control terminal, the method comprising:
identification by the device of all or some of control terminals located in a predefined geographical zone;
transmission of a request by the device to a remote server using a first communication protocol, said request being a request for at least one authentication code corresponding to at least one of the control terminals selected from the identified control terminals;
on reception of said request by the remote server, interrogation by the remote server of a table stored in a database, said table comprising a list of control terminals associated with respective authentication codes; and
in response to a determination that the selected control terminal and the corresponding authentication code are stored in the table, extraction by the remote server of the authentication code associated with the selected control terminal, transmission by the remote server of the extracted authentication code to the device using the first communication protocol, and transmission by the device of the extracted authentication code corresponding to the selected control terminal via a second communication protocol.

13. The method as claimed in claim 12, wherein each control terminal is a point of access to a shared network, the authentication code being required by the access point to authorize access of the device to said shared network.

14. The method as claimed in claim 12, wherein the second communication protocol is compatible with one of the following wired or wireless radio-communication standards: Ethernet, IEEE 802.11, IEEE 802.15, IEEE 802.16, RFID, PLC and NFC.

15. The method as claimed in claim 12, wherein the first communication protocol is compatible with an ultra narrow band radio technology.

16. The method as claimed in claim 12, wherein the identification step further comprises a phase of discovering all or some of the control terminals located in a geographical zone surrounding the device, and a step of retrieving an identifier of at least one of the discovered control terminals.

17. The method as claimed in claim 12, wherein the identification step further comprises steps of:
geo-locating the device via a geo-locating unit incorporated into the device; and
searching, in the list of control terminals stored in the database coupled to the device, for at least one control terminal located in a geographical zone surrounding the device.

18. The method as claimed in claim 12, further comprising a step of checking additional conditions associated with the control terminal selected to transmit the corresponding authentication code to the device.

19. The method as claimed in claim 12, wherein each control terminal is identifiable by its SSID or its MAC address.

20. A system to retrieve remotely at least one authentication code, comprising:
a remote server coupled to a table stored in a database and the table comprising a list of control terminals associated with respective authentication codes;
at least one control terminal; and
a device coupled to a first communication unit to exchange data with the remote server using a first communication protocol, and the device is coupled to a second communication unit to exchange data with said at least one control terminal using a second communication protocol;
wherein the device is configured to:
identify all or some of access terminals in a predefined geographical zone;
transmit a request to the remote server via the first communication unit to request at least one authentication code required by said at least one control terminal selected from identified control terminals; and
transmit a required authentication code to the selected control terminal via the second communication unit;
wherein the remove server configured to:
on reception of the request from the device, interrogate the table and extract an authentication code associated with the selected control terminal; and
transmit the extracted authentication code to the device using the first communication protocol.

21. The system as claimed in claim 20, wherein at least one of the first and second communication units is integrated into the device.

22. The system as claimed in claim 20, wherein the first communication unit module is configured to determine that the selected control terminal and the required authentication code are stored in the table, to extract the authentication code associated with the selected control terminal, and to transmit the extracted authentication code to the device using the first communication protocol.
